(19) United States
(12) Patent Application Publication
(10) Pub. No.: US 2025/0364603 A1
(43) Pub. Date: Nov. 27, 2025

(54) ALL-SOLID STATE BATTERY AND MANUFACTURING METHOD THEREOF

(71) Applicant: SAMSUNG SDI CO., LTD., Yongin-si, Gyeonggi-do (KR)

(72) Inventors: Minsuk LEE, Yongin-si, Gyeonggi-do (KR); Jaewon KIM, Yongin-si, Gyeonggi-do (KR); SUYEOL RYU, Yongin-si, Gyeonggi-do (KR); GUESUNG KIM, Yongin-si, Gyeonggi-do (KR); YOUNG GYOON RYU, Yongin-si, Gyeonggi-do (KR)

(21) Appl. No.: 18/872,513

(22) PCT Filed: Nov. 3, 2024
(86) PCT No.: PCT/KR2023/017564

§ 371 Date: Dec. 6, 2024

(30) Foreign Application Priority Data
Nov. 9, 2022 (KR) 10-2022-0148802

(51) Int. Cl. H01M 10/0585; H01M 4/02; H01M 4/04; H01M 4/62; H01M 50/54; H01M 50/595

(52) U.S. Cl. CPC H01M 10/0585; H01M 4/0435; H01M 4/623; H01M 50/54; H01M 50/595; H01M 2004/029; H01M 2200/00

(57) ABSTRACT

The present disclosure relates to a manufacturing method of an all-solid-state battery, and the manufacturing method of the all-solid-state battery of an embodiment includes supplying a reel-type mechanical structure sheet by partitioning a corresponding member having a blank corresponding to a positive electrode of a battery cell and a buffering part corresponding to the outside of the battery cell by repetition of a cutting line and a non-cut part; placing a magazine-type positive electrode on the blank; supplying a first solid electrolyte/negative electrode sheet and a second solid electrolyte/negative electrode sheet in a reel type by attaching a solid electrolyte and a negative electrode to the lower and upper parts of the mechanical structure sheet on which the positive electrode is assembled; pre-laminating the first solid electrolyte/negative electrode sheet, the mechanical structure sheet on which the positive electrode is assembled, and the second solid electrolyte/negative electrode sheet; and separating bi-cells by cutting a pre-laminated first laminate under pressure.

### TECHNICAL FIELD

The present invention relates to an all-solid-state battery and a manufacturing method thereof. More particularly, the present disclosure relates to an all-solid-state battery applying a uniaxial pressurization of a battery cell and a manufacturing method thereof.

### BACKGROUND ART

As an example, an all-solid-state battery includes a sulfide-based solid electrolyte and requires high pressurization. The pressurization process includes a warm isostatic press (WIP) using a liquid, a uniaxial plate press (P/P) using hydraulic pressure, and a roll press (R/P).

The warm isostatic press involves affixing the battery cells to a metal plate, vacuum packaging the entire assembly, and then pressurizing it. In other words, it is more suitable for pressurizing the all-solid-state battery including a sulfide solid electrolyte than other pressurizing processes due to a two-axis pressurization.

However, the WIP has two problems. First, mass productivity is very low due to packaging and unpackaging of pressurized parts. Second, the pressurization conditions of the metal surface and the packaging surface are different, and this difference creates an asymmetric surface in the stacking pressurization or the stacking of pressurized cells, and degrades the cell lifespan.

On the other hand, the P/P and the R/P are difficult to review in and of themselves. The properties of the sulfide solid electrolytes before and after pressurization are completely different. Solid electrolyte is a soft powder before pressurization, but after pressurization it becomes similar to a ceramic that breaks easily. Therefore, solid electrolytes are an unsuitable material for cumulative pressurization.

When applying the P/P or the R/P to such material, a deformation occurs due to non-uniform pressurization. This deformation causes a short circuit during the first charge. P/P or R/P is a uniaxial pressurization method. If the arrangement of the cell components is asymmetrical, the cell components are not pressurized at a certain ratio, are elongated along an axis to which no pressure is applied, and an elongation rate is different for each component, thereby it difficult to uniformly pressurize a multi-layer structure.

The all-solid-state battery containing solid electrolyte include a lithium ion intercalation, a lithium alloy, and a lithium deposition type, depending on how lithium is deposited on the negative electrode during the charging. The lithium deposition literally means that lithium ions are deposited to a metal at a negative electrode and accumulated, and a lithium metal is deposited during the charging regardless of whether there is an active material at the negative electrode.

The lithium deposition all-solid-state battery uses a negative electrode, and this negative electrode does not have a housing (housing-free). In the lithium deposition all-solid-state battery, lithium ions move from a positive electrode to the negative electrode during charging, are precipitated at the negative electrode, and dissociated and move to the positive electrode during the discharge.

During the charging, lithium is deposited on the negative electrode and the volume of the battery cell expands. In addition, if no pressure is applied to the battery cell, the lithium deposition is non-uniform in the free state, and in the process of charging and discharging, the non-uniformity is amplified, which may cause the solid electrolyte to partially break down, leading to a short circuit.

To solve the pressure non-uniformity of the lithium deposition battery cell, a pressure of 2-4 MPa is applied to the battery cell. Pure lithium has high reactivity. The lithium deposited on the negative electrode is pure lithium, easily reacts with residual impurities that may be gasified within the battery cell, and becomes oxidized.

Since the residual impurity in the all-solid-state battery cannot be adsorbed, the lithium that is oxidized through the reaction between the impurity and lithium becomes lithium that is not available during the discharge, causing capacity deterioration. In addition, if the lithium oxidation increases locally, the lithium oxidation has a high elasticity coefficient, so it may locally apply a stress to the solid electrolyte, causing a damage and a short circuit.

### DISCLOSURE

### Technical Problem

One embodiment provides a manufacturing method of an all-solid-state battery that applies a mechanical structure sheet for uniaxial pressurization of a battery cell. One embodiment provides a manufacturing method of an all-solid-state battery that enhances a buffering function of the mechanical structure, uniform pressurization of multi-layered components inside a battery cell, insulation of positive and negative electrodes, and safety of the battery.

One embodiment provides a manufacturing method of an all-solid-state battery that improves stack processability and productivity by changing the mechanical structure sheet and the solid electrolyte/negative electrode sheet from a magazine type to a reel type, applying a hybrid of a magazine-type positive electrode and a reel-to-sheet type, and applying pressure using a multi-stage vacuum roll press.

Another embodiment provides an all-solid-state battery manufactured by the manufacturing method of the all-solid-state battery.

### Technical Solution

A manufacturing method of an all-solid-state battery according to an embodiment includes a first step of supplying a mechanical structure sheet in a reel type by partitioning a corresponding member having a blank corresponding to a positive electrode of a battery cell and a buffering part corresponding to the outside of the battery cell by repetition of a cutting line and a non-cut part; a second step of placing a magazine-type positive electrode on the blank; a third step of supplying a first solid electrolyte/negative electrode sheet and a second solid electrolyte/negative electrode sheet in a reel type by attaching a solid electrolyte and a negative electrode to the lower and upper parts of the mechanical structure sheet on which the positive electrode is assembled, and the second solid electrolyte/negative electrode sheet; a fourth step of pre-laminating the first solid electrolyte/negative electrode sheet; and a fifth step of separating bi-cells by cutting a pre-laminated first laminate under a pressure.

The manufacturing method of the all-solid-state battery according to an embodiment may further include alternately laminating the bi-cells and buffering pads to form a second laminate.

The manufacturing method of the all-solid-state battery according to an embodiment may further include welding lead tabs of the positive electrode to each other and welding lead tabs of the negative electrode to each other in the second laminate, and inserting the second laminate into a case to complete a stack.

In supplying the mechanical structure sheet, the buffering part may be provided and supplied on both sides of the direction crossing the moving direction of the reel-type mechanical structure sheet.

In supplying the mechanical structure sheet, the mechanical structure sheet of one sheet may be supplied, and in placing the magazine-type positive electrode, the lead tab of the positive electrode in which a positive active material is provided on both sides assembled on the blank of one sheet may be joined to the groove of the corresponding member.

In placing the magazine-type positive electrode, an insulating tape may be attached to the solid electrolyte side of the lead tab of the positive electrode.

The mechanical structure sheet of two sheets may be supplied, and in placing the magazine-type positive electrode, the lead tab of the positive electrode in which a positive active material is provided on both sides assembled on each of two blank sheets may be joined to the groove of two corresponding members facing each other and drawn out between two corresponding members.

Pre-lamination may be performed after the alignment in a hybrid combination of a reel-to-sheet and a magazine.

In separating the bi-cells, the first laminate may be pressurized by a roll press.

An all-solid-state battery according to an embodiment includes a corresponding member having a blank; a positive electrode arranged in the blank so as to correspond to the blank of the corresponding member; and a solid electrolyte/negative electrode sheet that is joined together so as to be bonded to the positive electrode with a solid electrolyte, to form a bi-cell, wherein the corresponding member includes a separation part separated from a cutting line and a non-cut part in an uncut state on the periphery.

The all-solid-state battery according to an embodiment may include a laminate including a plurality of bi-cells and a plurality of buffering pads, and formed by alternately stacking the bi-cells and the buffering pads.

In the laminate, the lead tabs of the positive electrode may be welded to each other, and the lead tabs of the negative electrode may be welded to each other.

The corresponding member may have the cutting line on both sides of the direction in which the lead tab of the positive electrode and the lead tab of the negative electrode are drawn out and on both sides of the direction intersecting the drawn-out direction, and the separation part may be provided at the corner where the cutting lines intersect.

The corresponding member may be formed as one, the positive electrode may be assembled on the blank with the positive active material on both sides, and the lead tab of the positive electrode may be bent and joined to the groove of the corresponding member.

The lead tab of the positive electrode may further include an insulating tape that is attached to the solid electrolyte side.

The corresponding member may be formed of two sheets, the positive electrode may be assembled on the blank with a positive active material on both sides, and the lead tab of the positive electrode may be joined to the groove of two corresponding members facing each other and drawn out between two corresponding members.

The corresponding member may further include an adsorption flame-retardant film including a pulp fiber, a glass fiber, Al(OH)₃, and a binder.

The binder may include at least one H-NBR, PVDF-HFP, and polyacrylate. The adsorption flame-retardant film may be coated on both sides of the corresponding member.

The content of the binder may be 1-20 wt %. The content of the binder may be 5-10 wt %.

### Advantageous Effects

One embodiment applies the mechanical structure sheet having the corresponding member for assembling the positive electrode and the buffering part corresponding to the exterior of the battery cell, thereby enabling uniaxial pressurization of the battery cell.

One embodiment applies the mechanical structure sheet to provide a buffering function with the buffering part and the corresponding member, induce uniform pressurization of multi-layered parts inside the battery cell, implement insulation between the positive and negative electrodes, and enhance the safety of the battery.

One embodiment applies a reel-type application of the mechanical structure sheet and the solid electrolyte/negative electrode sheet and a magazine-type application of the positive electrode, so that stack processability and productivity may be improved by applying pressure with a vacuum multi-stage roll press.

### DESCRIPTION OF THE DRAWINGS

FIG. 1 is a flowchart of a manufacturing method of an all-solid-state battery according to an embodiment.

FIG. 2 is a top plan view of a first step of supplying a mechanical structure sheet in a manufacturing method of an all-solid-state battery

FIG. 3A is a view showing a second step of assembling a positive electrode on a blank of a mechanical structure sheet. FIG. 3B is a top plan view of a third step of supplying a solid electrolyte/negative electrode sheet formed by attaching a solid electrolyte and a negative electrode.

FIG. 4A is a top plan view of a fourth step of pre-laminating a first solid electrolyte/negative electrode sheet, a mechanical structure sheet on which a positive electrode is assembled, and a second solid electrolyte/negative electrode sheet. FIG. 4B is a side view thereof.

FIG. 5A is a top plan view of a positive electrode. FIG. 5B is a cross-sectional view before assembly. FIG. 5C is a cross-sectional view after assembly. FIG. 5D is an enlarged view thereof.

FIG. 6 is a top plan view showing a step of pressurizing a first laminate, which consists of a first solid electrolyte/negative electrode sheet that is bonded, a mechanical structure sheet on which a positive electrode is assembled, and a second solid electrolyte/negative electrode sheet.

FIG. 7A is a top plan view of a pressurized first laminate being separated into bi-cells. FIG. 7B is a top plan view of a separated bi-cell.

FIG. 8 is an exploded perspective view of an arrangement with buffering pads on both sides of a separated bi-cell.

FIG. 9 is a cross-sectional view of an all-solid-state battery according to a first embodiment of the present invention including a bi-cell and a buffering pad of FIG. 8.

FIG. 10 is a cross-sectional view of an all-solid-state battery according to a second embodiment of the present invention.

### MODE FOR INVENTION

Hereinafter, the present invention will be described more fully with reference to the accompanying drawings, in which embodiments of the invention are shown. As those skilled in the art would realize, the described embodiments may be modified in various different ways, all without departing from the spirit or scope of the present invention. The drawings and description are to be regarded as illustrative and not restrictive in nature, and like reference numerals designate like elements throughout the specification.

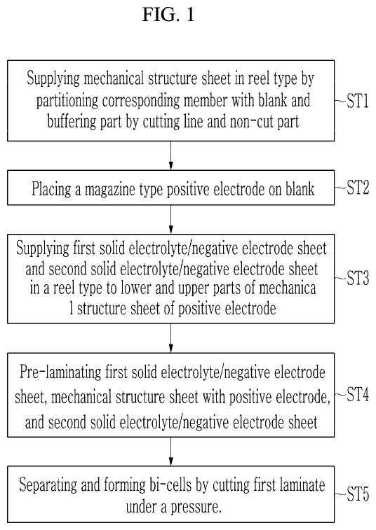

FIG. 1 is a flowchart of a manufacturing method of an all-solid-state battery according to an embodiment. Referring to FIG. 1, the manufacturing method of the all-solid-state battery in an embodiment includes a first step ST1, a second step ST2, a third step ST3, a fourth step ST4, and a fifth step ST5. An embodiment enables preemptive blocking of effects of physical defects that cause short circuits in all-solid-state batteries. Therefore, the embodiment may improve the charging and discharging lifespan, prevent a sudden decrease in a battery capacity due to the short circuit, reduce cost, and improve mass production.

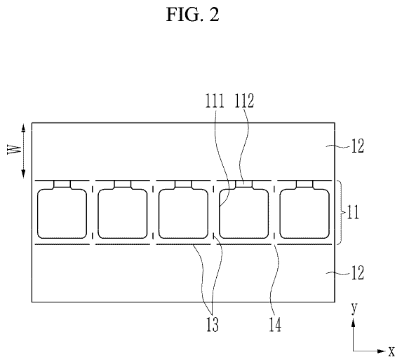

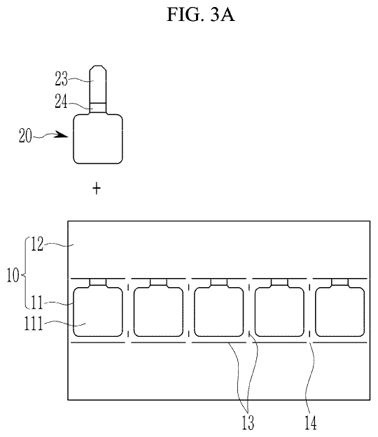

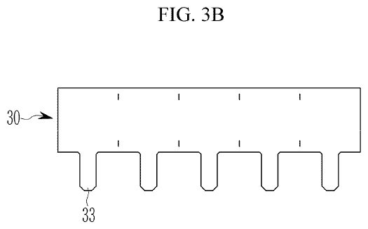

FIG. 2 is a top plan view of a first step of supplying a mechanical structure sheet in a manufacturing method of an all-solid-state battery

Referring to FIG. 1 and FIG. 2, in the first step ST1, a mechanical structure sheet 10 is supplied in a reel type.

The mechanical structure sheet 10 includes a corresponding member 11 having a blank 111 corresponding to a positive electrode 20 of the battery cell, and a buffering part 12 corresponding to the exterior of the battery cell. The mechanical structure sheet 10 is formed by partitioning the corresponding member 11 and the buffering part 12 into repetitions of cutting lines 13 and non-cut parts 14.

In the first step ST1, the buffering part 12 is provided and supplied on both sides in a direction (y-axis direction) intersecting the moving direction (x-axis direction) of the mechanical structure sheet 10 of the reel type. The buffering part 12 has a predetermined width w in the y-axis direction to achieve buffering performance.

In the mechanical structure sheet 10, the buffering part 12 does not form the all-solid-state battery 1, but enables uniform roll pressing. The corresponding member 11 is included in an internal configuration of the all-solid-state battery 1, and suppresses lateral elongation of positive active materials 21 and 22, the solid electrolyte, and the negative active material, and enables uniform roll pressing throughout. After the roll pressing is completed, the buffering part 12 is removed, and the non-cut part 14 of the corresponding member 11 is separated by a laser or a mold.

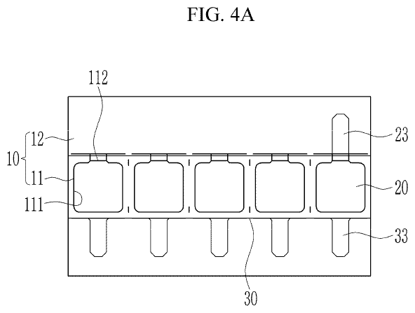

FIG. 3A is a view showing a second step of assembling a positive electrode on a blank of a mechanical structure sheet. FIG. 3B is a top plan view of a third step of supplying a solid electrolyte/negative electrode sheet formed by attaching a solid electrolyte and a negative electrode.

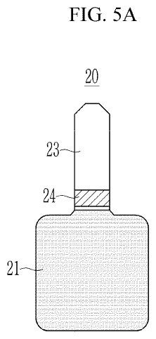

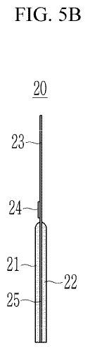

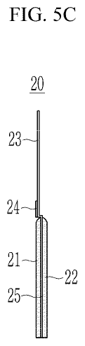

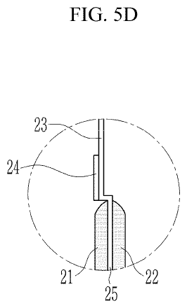

Referring to FIG. 1, FIG. 3A, and FIG. 3B, in the second step ST2, a magazine-type positive electrode 20 is disposed on the blank 111. In the first step ST1, the mechanical structure sheet 10 is supplied as one sheet. In the positive electrode 20, a positive active material (21, 22, referring to FIG. 5) is provided on both sides of a current collector 25.

In the second step ST2, a lead tab 23 of the positive electrode 20 assembled on the blank 111 of one sheet is joined to a groove 112 of the corresponding member 11, and the lead tab 23 is temporary bonded and bent by pressing. Although not shown, the lead tab may be bent and joined to the groove. The positive electrode 20 may be pre-pressurized and joined to the blank 111. Additionally, in the second step ST2, an insulating tape 24 is attached to the solid electrolyte side of the lead tab 23 of the positive electrode 20.

In the third step ST3, a solid electrolyte/negative electrode sheet 30 formed by attaching a solid electrolyte and a negative electrode is supplied in a reel type. The solid electrolyte/negative electrode sheet 30 includes a first solid electrolyte/negative electrode sheet 31 and a second solid electrolyte/negative electrode sheet 32.

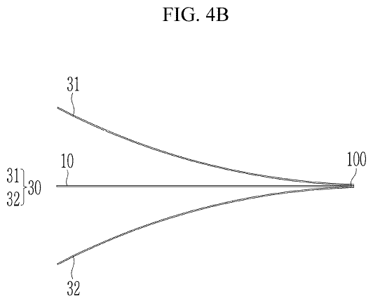

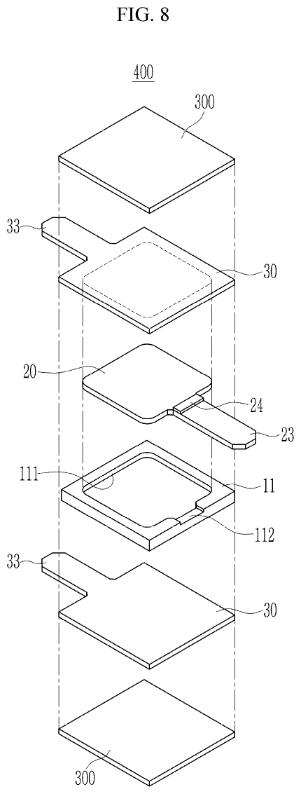

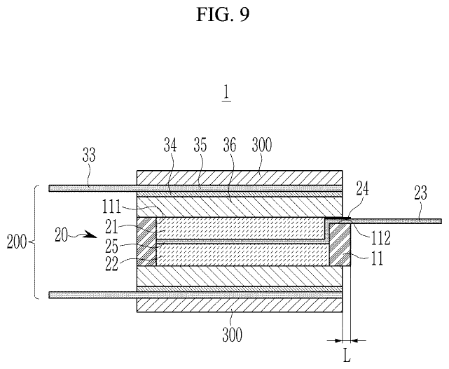

That is, in the third step ST3, the first solid electrolyte/negative electrode sheet 31 and the second solid electrolyte/negative electrode sheet 32 are supplied in a reel type to the upper and lower parts of the mechanical structure sheet 10 on which the positive electrode 20 is assembled (referring to FIG. 4B and FIG. 9).

In the first laminate 100 of the mechanical structure sheet 10 and the second solid electrolyte/negative electrode sheet 32, in which the first solid electrolyte/negative electrode sheet 31 and the positive electrode 20 of the reel type are assembled, a cutting line 13 may be a reference line for the cutting after the bonding and pressing, and the first laminate 100 may be applied with a sophisticated punch die or a laser for the cutting or the separating.

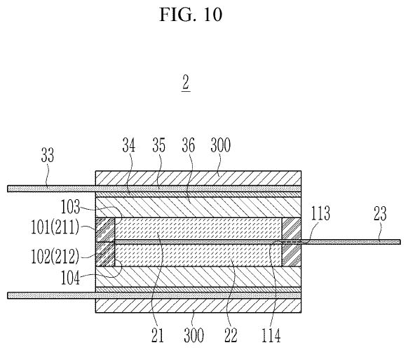

Additionally, in the first step ST1, two sheets of the mechanical structure sheets 211 and 212 are supplied. In the second step ST2, the lead tab 23 of the positive electrode 20 having the positive active materials 21 and 22 on both sides assembled on two blanks 103 and 104, is joined to the grooves 113 and 114 of two corresponding members 101 and 102 facing each other and drawn out between two corresponding members 101 and 102 (referring to FIG. 10). In this case, the lead tab 23 of the positive electrode 20 is not bent.

FIG. 4A is a top plan view of a fourth step of pre-laminating a first solid electrolyte/negative electrode sheet, a mechanical structure sheet on which a positive electrode is assembled, and a second solid electrolyte/negative electrode sheet. FIG. 4B is a side view thereof.

Referring to FIG. 1, FIG. 4A, and FIG. 4B, in the fourth step ST4, the first solid electrolyte/negative electrode sheet 31, the mechanical structure sheet 10 in which the positive electrode 20 is assembled, and the second solid electrolyte/negative electrode sheet 32 are pre-laminated. In the fourth step ST4, a hybrid combination of a reel-to-sheet and a magazine may be used to perform alignment and pre-lamination.

For example, pre-lamination is possible at a temperature between 6° and 80° C., a pressure between 2 and 5 MPa, and a time between 1 and 10 m/min. The pre-lamination process of the first laminate 100 consists of the hybrid combination of the reel-to-sheet and the magazine. The pre-lamination process simplifies the alignment and bonding compared to the warm isostatic pressing (WIP) in a liquid environment.

FIG. 5A is a top plan view of a positive electrode. FIG. 5B is a cross-sectional view before assembly. FIG. 5C is a cross-sectional view after assembly. FIG. 5D is an enlarged view. Referring to FIG. 5A to FIG. 5D, the positive electrode 20 has positive active materials 21 and 22 on both sides of the current collector 25.

The lead tab 23 of the positive electrode 20 is connected to the current collector 25 as an uncoated region and, when being assembled into the blank 111, is bent to form a step and joined to the groove 112 of the corresponding member 11. The insulating tape 24 is attached to the solid electrolyte side of the lead tab 23 of the positive electrode 20 to prevent a short circuit with the solid electrolyte/negative electrode sheet 30 (referring to FIG. 9).

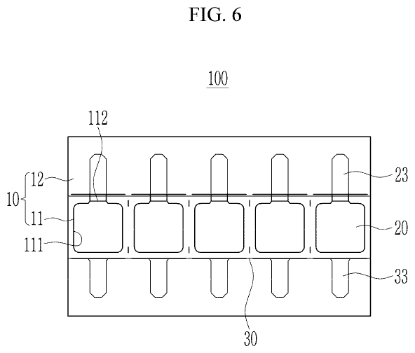

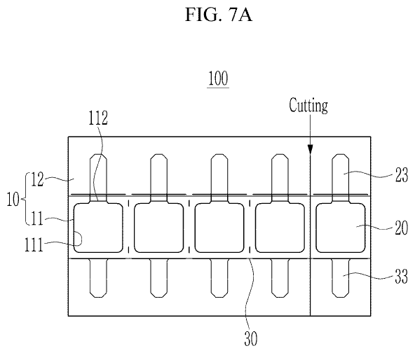

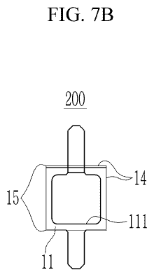

FIG. 6 is a top plan view showing a step of pressurizing a first laminate, which consists of a first solid electrolyte/negative electrode sheet that is bonded, a mechanical structure sheet on which a positive electrode is assembled, and a second solid electrolyte/negative electrode sheet. FIG. 7A is a top plan view of a pressurized first laminate being separated into bi-cells. FIG. 7B is a top plan view of a separated bi-cell.

Referring to FIG. 6, FIG. 7A, and FIG. 7B, in the fifth step ST5 the pre-laminated first laminate 100 is pressurized and cut to separate bi-cells 200. For example, in the fifth step ST5, the first laminate 100 is pressurized with a roll press.

The vacuum warm roll press of the first laminate 100 is possible with a temperature between 9° and 150° C., a maximum line pressure of 5 ton/cm, a vacuum degree of 1 Torr, a time between 1 and 10 m/min, and a multi-step roll press. The roll press is possible with between 2 and 5 step pressurizations.

After the multi-step roll press of the vacuum, the first laminate 100 is cut using the cutting line 13 as a reference and separated into 200 bi-cells. The cutting process may be applied using a punch-die system or a laser cutting.

FIG. 8 is an exploded perspective view of an arrangement with buffering pads on both sides of a separated bi-cell. Referring to FIG. 8, the manufacturing method of the all-solid-state battery according to an embodiment further includes a sixth step ST6. In the sixth step ST6, the bi-cells 200 and the buffering pads 300 are alternately laminated to form a second laminate 400.

The manufacturing method of the all-solid-state battery according to an embodiment further includes a seventh step ST7. In the seventh step ST7, in the second laminate 400, the lead tabs 23 of the positive electrode 20 are welded to each other, negative electrode lead tabs 33 of the solid electrolyte/negative electrode sheet 30 are welded to each other, and the second laminate 400 is inserted in a pouch or case (not shown), thereby completing a stack.

The stack forming the all-solid-state battery 1 may be stacked in 20 to 30 layers by alternately stacking the bi-cells 200 and the buffering pads 300.

Hereinafter, all-solid-state batteries manufactured using the above-described manufacturing method are described. FIG. 9 is a cross-sectional view of an all-solid-state battery according to a first embodiment of the present invention including the bi-cell and the buffering pad of FIG. 8.

Referring to FIG. 9, an all-solid-state battery 1 of the first embodiment forms a bi-cell 200 by including a corresponding member 11 having a blank 111, a positive electrode 20 arranged and formed to correspond to the blank 111 of the corresponding member 11, and a solid electrolyte/negative electrode sheet that is joined so as to be adhered to the positive electrode 20 as a solid electrolyte.

The corresponding member 11 is arranged on the periphery of the positive electrode 20, including the cutting line 13 and the separation part 15 separated from the non-cut part 14 in an uncut state. The corresponding member 11 further includes an adsorptive flame-retardant film including a pulp fiber, a glass fiber, Al(OH)₃, and a binder.

The glass fiber increases the strength of the pulp fiber, and Al(OH)₃ acts as an H₂O adsorptive agent below 100° C. and has a flame-retardant effect for composite materials above 160° C. The binder provides a bonding strength and includes at least one of H-NBR, PVDF-HFP, and polyacrylate.

An adsorptive flame-retardant film is coated on both sides of the corresponding member 11. As an example, the content of the binder is 1˜20 wt %. Additionally, the content of the binder may be 5˜10 wt %. The adsorptive flame-retardant film may improve the battery cell lifespan by the adsorption of the residual impurity and improve the safety of the battery cell by applying the flame-retardant material.

The corresponding member 11 provides uniform pressurization to the solid electrolyte/negative electrode sheet 30 during the warm roll pressing in the vacuum of the stacked bi-cell 200, and also provides uniform pressurization during battery cell evaluation.

The corresponding member 11 removes residual moisture (H₂O) that has inflowed into an aluminum pouch and residual moisture that may be generated during charging and discharging. Additionally, the corresponding member 11 releases moisture (H₂O) in high-temperature conditions of 160° C. or higher due to abuse to prevent the temperature of the battery cell from rising further.

Referring to FIG. 9, FIG. 7A, and FIG. 7B, the corresponding member 11 includes the lead tab 23 of the positive electrode 20 and the cutting line 13 provided on both sides of the direction in which the lead tab 33 as the negative uncoated region of the solid electrolyte/negative electrode sheet 30 is drawn out and on both sides of the direction intersecting the drawn-out direction, and includes the separation part 15 separated from the non-cut part 14 at the corner where the cutting lines 13 intersect.

The corresponding member 11 is formed as one piece, the positive electrode 20 is provided with the positive active materials 21 and 22 on both sides and is assembled on the blank 111, and the lead tab 23 of the positive electrode is bent and joined to the groove 112 of the corresponding member 11.

Referring to FIG. 9 and FIG. 5, the lead tab 23 of the positive electrode includes the insulating tape 24 attached to the solid electrolyte side. The insulating tape 24 prevents the detachment of the positive active materials 21 and 22, and a short circuiting of the lead tab 23 and the solid electrolyte/negative electrode sheet 30.

For example, the positive electrode 20 is formed by coating a carbon primer layer with a thickness of 1˜3 μm on both sides of an aluminum (Al) current collector 25, and applying the positive active material layers 21 and 22 on the carbon primer layer.

The protrusion range of the positive active material 21 toward the lead tab 23 side is a maximum of 0.7 mm, and the insulating tape 24 is taped toward the lead tab 23 side with a thickness of 10˜30 μm and a length of 2˜3 mm. The insulating tape 24 attached to the surface of the positive active material 21 prevents the detachment of the positive active material 21 and short circuit of the first laminate 100.

Although not shown separately, an insulating tape is attached to the solid electrolyte side of the lead tab of the negative electrode current collector to prevent the detachment of the negative active material and short circuiting between the lead tab of the negative electrode current collector and the positive electrode.

On the other hand, the corresponding member 11 has a protrusion length L that protrudes further than the outermost portion of the solid electrolyte/negative electrode sheet 30, and the lead tab 23 is supported further on the corresponding member 11 by the protrusion length L. In this case, the insulating tape 24 further covers the lead tab 23 on the corresponding member 11 by the protrusion length L, thereby further improving the insulation performance of the lead tab 23.

For example, the solid electrolyte/negative electrode sheet 30 is formed by coating the negative active material 34 on one surface of a negative electrode current collector 35 made of stainless steel (SUS) or nickel-coated copper (Ni-coated Cu), and laminating the solid electrolyte (SE) 36 on the negative active material 34.

The negative active material 34 is formed on the negative electrode current collector 35, and the solid electrolyte is formed thereon. As an example, the solid electrolyte 36 is formed as lithium argyrodite. The solid electrolyte/negative electrode sheet 30 may be laminated by direct coating of a solid electrolyte slurry, a transfer of a solid electrolyte film, or a lamination junction of a free-standing solid electrolyte film and a negative active material. The free-standing solid electrolyte membrane includes a non-woven fabric with a thickness of 15 μm inside.

In addition, the corresponding member is attached to the solid electrolyte of the solid electrolyte/negative electrode by a thermally pressure, thereby creating a laminate of the corresponding member and the solid electrolyte/negative electrode. This laminate is laminated with the positive electrode and is pressurized in multiple stages using a warm press to manufacture the bi-cell (not shown).

The corresponding member 11 is formed of a pulp system having electrical insulation and flame-retardant properties. The groove 112 is formed wider by the protrusion length L on the lead tab 23 side of the positive electrode than on the lead tab 33 side of the solid electrolyte/negative electrode sheet 30. The groove 112 has a depth corresponding to the thickness of the lead tab 23 of the positive electrode 20, thereby reducing the deformation of the solid electrolyte by the lead tab 23.

As an example, the buffering pad 300 is formed of a polyurethane elastic member, an acryl-based elastic member, or a silicon-based rubber, and provides buffering power and an elastic force to form a planarity when lithium is precipitated at the negative electrode during charging and discharging, and when the lithium precipitated at the negative electrode dissociates.

Aluminum tabs and nickel tabs with an insulating tape are welded to the lead tabs 23 and 33 of the positive electrode 20 and the negative electrode 30, respectively (not shown), and a buffering pad 300 is attached to the outermost part of the bi-cell 200 and vacuum-packed in an aluminum pouch to complete the all-solid-state battery 1.

Below, an all-solid-state battery 2 of a second embodiment is described. When comparing the second embodiment to the first embodiment, descriptions of the same components are omitted and descriptions of different components are provided.

FIG. 10 is a cross-sectional view of an all-solid-state battery according to a second embodiment of the present invention. Referring to FIG. 10, the all-solid-state battery 2 of the second embodiment comprises two corresponding members 101 and 102. The positive electrode 20 is assembled on the blanks 103 and 104 with the positive active materials 21 and 22 on both sides.

The lead tab 23 of the positive electrode 20 is connected to the grooves 113 and 114 of two corresponding members 101 and 102 on both sides and drawn out between the two corresponding members 101 and 102. In this case, the lead tab 23 is not bent.

For convenience, referring to the first embodiment, the bi-cell 200 may be created by thermally bonding the corresponding member 11 to the solid electrolyte 36 of the solid electrolyte/negative electrode sheet 30, thereby manufacturing the first laminate 100 of the corresponding member 11 and the solid electrolyte/negative electrode sheet 30, and laminating the first laminate 100 with the positive electrode 20 and pressurized in multiple stages using a warm roll press.

The corresponding member 11 forms a gap within a tolerance range between the positive active materials 21 and 22, but does not form a gap larger than the tolerance range, thereby enabling uniform pressurization during roll pressing, thereby preventing short circuiting during charging.

If the positive active materials 21 and 22 are larger than the blank 111, the corresponding member 11 is deformed, and if the positive active materials 21 and 22 are smaller than the blank 111 of the corresponding member 11, a gap is formed between the corresponding member 11 and the positive active materials 21 and 22. There is no gap larger than the tolerance because the solid electrolyte corresponding to the gap is pressurized unevenly.

The corresponding member 11 is formed of a porous fabric and has a binder applied thereto. The porous fabric shrinks only in the vertical direction in the multi-roll press and does not stretch laterally. Therefore, short circuit is prevented by the uniform pressurization of the first laminate 100 as no lateral elongation occurs. The porous fabric prevents formation of air pockets inside during vacuum pressurization. The occurrence of short circuits is prevented by uniform pressurization, preventing air pockets.

A binder coated on the corresponding member 11—for example, H-NBR-affixes the solid electrolyte and the corresponding member 11. Alignment of the solid electrolyte/negative electrode sheet 30 and the corresponding member 11 is improved during pre-lamination, and this prevents short-circuiting by uniform pressurization during roll pressing.

As an experimental example, the corresponding member 11 may shrink by 50% of the thickness after pressurization. When the pressure of the roll press is 5 tonf/cm², the thickness of the corresponding member 11 shrinks from 300 μm to 150 μm. The buffering pad 300 may be formed of acrylic foam or polyurethane foam. The thickness of the foam is 300 μm.

In the roll press, the diameter and length of the roll is $450×300 mm, the effective length is 120 mm, the line pressure is 2.0 tonf/cm², and the temperature is 120° C. The area of the first laminate 100 that is bonded is 129×85 mm in the y-axis direction and the x-axis direction.

The specific capacity (mAh/g) of the positive active materials 21 and 22 is 200, the positive active material is 85%, mass per area (mg/cm²) is 20.56, and current density (mAh/cm²) is 4.11. When the roll press is applied by pre-pressurizing the positive electrode 20 to the maximum, no further change in thickness occurs in the positive electrode 20.

The mechanical structure sheet 10 is a porous fabric itself, and when being pressurized, the thickness shrinks by up to 50%, and there is almost no elongation in the horizontal direction. The process is carried out by placing the roll press in the vacuum chamber.

TABLE 1

| | Mechanical structure sheet assembled with positive electrode | | | | | | | | |
|---|---|---|---|---|---|---|---|---|---|
| | | | | Mechanical structure sheet | | | | | |
| | Positive active material | | | Surface coating | | Buffering | | Evolution | Short |
| | Pre- | Thickness | Density | | Content | part w | Vacuum | Pressure | occurrence |
| | pressure | (mm) | (g/cm³) | Binder | (wt %) | (mm) | 1 Torr | uniformity | time |
| Experimental | Applying | 150 | 3.5 | H- | 10 | 100 | Applying | Δ | <150 |
| Example 1 | | | | NBR | | | | | |
| Experimental | Applying | 150 | 3.5 | H- | 10 | 50 | Applying | ⊙ | >300 |
| Example 2 | | | | NBR | | | | | |
| Experimental | Applying | 150 | 3.5 | H- | 10 | 30 | Applying | ⊙ | >250 |
| Example 3 | | | | NBR | | | | | |
| Experimental | Applying | 150 | 3.5 | H- | 10 | 20 | Applying | ◯ | <220 |
| Example 4 | | | | NBR | | | | | |
| Experimental | Applying | 150 | 3.5 | H- | 10 | 10 | Applying | ◯ | <200 |
| Example 5 | | | | NBR | | | | | |
| Experimental | Applying | 150 | 3.5 | H- | 10 | 5 | Applying | ◯ | <180 |
| Example 6 | | | | NBR | | | | | |
| Experimental | Applying | 150 | 3.5 | H- | 10 | 3 | Applying | Δ | <150 |
| Example 7 | | | | NBR | | | | | |
| Experimental | Applying | 150 | 3.5 | H- | 10 | 1 | Applying | Δ | <120 |
| Example 8 | | | | NBR | | | | | |
| Comparative | No | 232 | 3.5 | No | 0 | 0 | Applying | X | <1 |
| Example 1 | applying | | | | | | | | |
| Comparative | Applying | 150 | 3.5 | No | 0 | 0 | Applying | X | <1 |
| Example 2 | | | | | | | | | |
| Comparative | Applying | 150 | 3.5 | No | 0 | 0 | Applying | X | <1 |
| Example 3 | | | | | | | | | |
| Comparative | Applying | 150 | 3.5 | Applying | 10 | 0 | No | X | <1 |
| Example 4 | | | | | | | | | |
| Comparative | Applying | 150 | 3.5 | H- | 10 | 0 | Applying | Δ | <100 |
| Example 5 | | | | NBR | | | | | |

⊙ (very good),
◯ (good),
Δ (normal),
X (poor)

Referring to Table 1, in Experimental Examples 1 to 8, all positive electrodes 20 were pre-pressurized and a binder HNBR was applied to a mechanical structure sheet 10. The content of the binder was 10 wt %.

The roll press was fixed. That is, the temperature was 120° C., the pre-pressure was 2.0 tonf/cm, the width w of the buffering part 12 of the mechanical structure sheet 10 was changed from 1 to 100 mm. The length of the roll press was 300 mm, and the effective length was 120 mm.

When the width w of the buffering part 12 is less than 3 mm, the pressurization uniformity is poor, when it is 5˜20 mm, the pressurization uniformity is good, when it is 30˜50 mm, the pressurization uniformity is very good, and when it is 100 mm, the pressurization uniformity is poor.

Evaluation showed that if the width w of the buffering part 12 differs significantly from the effective length, roll parallelism deteriorates and the pressurization uniformity deteriorates.

Evaluation showed that if the buffering part 12 is too large, pressurization uniformity decreases, and if it is too small, the role cannot be performed.

In the comparative example, pre-pressurization, the mechanical structure sheet, and the binder were not applied to the positive electrode, and no vacuum was applied during roll pressing. Therefore, referring to the comparative examples and the experimental examples, it may be seen that the positive electrode 20 must be pre-pressurized, and in order to overcome the short circuit, the mechanical structure sheet 10 and the vacuum must be applied.

The all-solid-state battery 1 including sulfide solid electrolytes 36 requires specific pressurization during manufacturing and the charging and discharging evaluation. Therefore, physical defects and non-uniformity within the battery cell contribute to the occurrence of short circuits. Therefore, pre-pressurization of the positive electrode 20 and application of the mechanical structure sheet 10 ameliorate the occurrence of short circuits.

In addition, when applying the roll press, it was found that the mechanical structure sheet 10 and the buffering part 12 enable uniform pressurization, and the effect thereof is reduced if the width w of the buffering part 12 is too small or too large. It was confirmed that the all-solid-state battery 1 with a lifespan of more than 200 cycles may be manufactured by the roll pressing method when pre-pressurization of the positive electrode 20 and the width w of the mechanical structure sheet 10 and the buffering part 12 are optimized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

(Description of Symbols)

| | |
|---|---|
| 1, 2: all-solid-state battery | 10: mechanical structure sheet |
| 11: corresponding member | 12: buffering part |
| 13: cutting line | 14: non-cut part |
| 15: separation part | 20: positive electrode |
| 21, 22: positive active material | 23: lead tab |
| 24: insulating tape | 25: current collector |
| 30: solid electrolyte/negative | |
| electrode sheet | |
| 31: first solid electrolyte/negative | |
| electrode sheet | |
| 33: lead tab | 32: second solid electrolyte/negative |
| | electrode sheet |
| 34: negative active material | 36: solid electrolyte |
| 35: negative electrode current | 100: first laminate |
| collector | |
| 103, 104: blank | 101, 102: corresponding member |
| 111: blank | 112: groove |
| 113, 114: groove | 211, 212: mechanical structure sheet |
| 200: bi-cell | 300: buffering pad |
| 400: second laminate | L: protrusion length |
| W: width | |

1. A manufacturing method of an all-solid-state battery comprising:
supplying a mechanical structure sheet in a reel type by partitioning a corresponding member having a blank corresponding to a positive electrode of a battery cell and a buffering part corresponding to the outside of the battery cell by repetition of a cutting line and a non-cut part;
placing a magazine-type positive electrode on the blank;
supplying a first solid electrolyte/negative electrode sheet and a second solid electrolyte/negative electrode sheet in a reel type by attaching a solid electrolyte and a negative electrode to the lower and upper parts of the mechanical structure sheet on which the positive electrode is assembled;
pre-laminating the first solid electrolyte/negative electrode sheet, the mechanical structure sheet on which the positive electrode is assembled, and the second solid electrolyte/negative electrode sheet; and
separating bi-cells by cutting a pre-laminated first laminate under pressure.

2. The manufacturing method of the all-solid-state battery of claim 1, further comprising:
alternately laminating the bi-cells and buffering pads to form a second laminate.

3. The manufacturing method of the all-solid-state battery of claim 2, further comprising:
welding lead tabs of the positive electrode to each other and welding lead tabs of the negative electrode to each other in the second laminate, and inserting the second laminate into a case to complete a stack.

4. The manufacturing method of the all-solid-state battery of claim 1, wherein:
in supplying the mechanical structure sheet
the buffering part is provided and supplied on both sides of the direction crossing the moving direction of the reel-type mechanical structure sheet.

5. The manufacturing method of the all-solid-state battery of claim 1, wherein:
in supplying the mechanical structure sheet, the mechanical structure sheet of one sheet is supplied, and
in placing the magazine-type positive electrode, the lead tab of the positive electrode in which a positive active material is provided on both sides assembled on the blank of one sheet is joined to the groove of the corresponding member.

6. The manufacturing method of the all-solid-state battery of claim 5, wherein:
in placing the magazine-type positive electrode,
an insulating tape is attached to the solid electrolyte side of the lead tab of the positive electrode.

7. The manufacturing method of the all-solid-state battery of claim 1, wherein:
in supplying the mechanical structure sheet, the mechanical structure sheet of two sheets is supplied, and
in placing the magazine-type positive electrode,
the lead tab of the positive electrode in which a positive active material is provided on both sides assembled on each of two sheet blanks is joined to the groove of two corresponding members facing each other and drawn out between two corresponding members.

8. The manufacturing method of the all-solid-state battery of claim 1, wherein:
in the pre-laminating,
pre-lamination is performed after alignment in a hybrid combination of a reel-to-sheet and a magazine.

9. The manufacturing method of the all-solid-state battery of claim 1, wherein:
in separating the bi-cells,
the first laminate is pressurized by a roll press.

10. An all-solid-state battery comprising:
a corresponding member having a blank;
a positive electrode arranged in the blank so as to correspond to the blank of the corresponding member; and
a solid electrolyte/negative electrode that is joined together so as to be bonded to the positive electrode with a solid electrolyte, to form a bi-cell,
wherein the corresponding member includes a separation part separated from a cutting line and a non-cut part in an uncut state on the periphery.

11. The all-solid-state battery of claim 10, wherein:
a laminate including a plurality of bi-cells and a plurality of buffering pads, formed by alternately stacking the bi-cells and the buffering pads, is included.

12. The all-solid-state battery of claim 11, wherein:
in the laminate, the lead tabs of the positive electrode are welded to each other, and the lead tabs of the negative electrode are welded to each other.

13. The all-solid-state battery of claim 10, wherein:
the corresponding member has the cutting line on both sides of the direction in which the lead tab of the positive electrode and the lead tab of the negative electrode are drawn out and on both sides of the direction intersecting the drawn-out direction, and
the separation part is provided at the corner where the cutting lines intersect.

14. The all-solid-state battery of claim 10, wherein:
the corresponding member is formed as one,
the positive electrode is assembled on the blank with the positive active material on both sides, and
the lead tab of the positive electrode is bent and joined to the groove of the corresponding member.

15. The all-solid-state battery of claim 14, wherein:
the lead tab of the positive electrode further includes an insulating tape that is attached to the solid electrolyte side.

16. The all-solid-state battery of claim 10, wherein:
the corresponding member is formed of two sheets,
the positive electrode is assembled on the blank with a positive active material on both sides, and
the lead tab of the positive electrode is joined to the groove of two corresponding members facing each other and drawn out between two corresponding members.

17. The all-solid-state battery of claim 10, wherein:
the corresponding member further includes an adsorptive flame-retardant film including a pulp fiber, a glass fiber, Al(OH)₃, and a binder.

18. The all-solid-state battery of claim 17, wherein:
the binder includes at least one of H-NBR, PVDF-HFP, and polyacrylate.

19. The all-solid-state battery of claim 17, wherein:
the adsorptive flame-retardant film is coated on both sides of the corresponding member.

20. The all-solid-state battery of claim 18, wherein:
the content of the binder is 1˜20 wt %.

21. The all-solid-state battery of claim 18, wherein:
the content of the binder is 5˜10 wt %.
